(19) United States
(12) Patent Application Publication
(10) Pub. No.: US 2026/0164043 A1
(43) Pub. Date: Jun. 11, 2026

(54) ELECTRONIC DEVICE AND VIDEO PROCESSING METHOD

(71) Applicant: Samsung Electronics Co., Ltd., Suwon-si (KR)

(72) Inventor: Hyungjun LIM, Suwon-si (KR)

(21) Appl. No.: 19/320,476

(22) Filed: Sep. 5, 2025

Related U.S. Application Data
(63) Continuation of application No. PCT/KR2025/013082, filed on Aug. 27, 2025.

(30) Foreign Application Priority Data
Dec. 11, 2024 (KR) 10-2024-0184063

(51) Int. Cl. H04N 19/186; G06V 10/56; G06V 10/60; H04N 19/117

(52) U.S. Cl. CPC H04N 19/186; G06V 10/56; G06V 10/60; H04N 19/117

(57) ABSTRACT

An electronic device comprises: a communication interface, display configured to reproduce a video signal, memory storing at least one instruction, and at least one processor electrically connected to the communication interface, the display, and the memory, and configured to execute the at least one instruction. The at least one processor receives a video input through the communication interface, obtain, based on the video input, a set of luminance values and a set of color values corresponding to positions of each of a series of pixels, determines, based on one set of the set of luminance values or the set of color values, p candidate sets by shifting corresponding pixel positions of each value belonging to the one set by each of the p values for each of a plurality of predetermined p values, determines correlations between another set of the set of luminance values or the set of color values and each of the candidate sets, selects one P value from the plurality of P values based on the correlations, and generate the video signal to be reproduced by the display based on the selected P value.

### CROSS-REFERENCE TO RELATED APPLICATIONS

This application is a continuation of International Application No. PCT/KR2025/013082 designating the United States, filed on Aug. 27, 2025, in the Korean Intellectual Property Receiving Office and claiming priority to Korean Patent Application No. 10-2024-0184063, filed on Dec. 11, 2024, in the Korean Intellectual Property Office, the disclosures of each of which are incorporated by reference herein in their entireties.

### BACKGROUND

### Field

The disclosure relates to a video processing method for a display device, and for example, to a video processing method for correcting phase errors of color signals for luminance signals and a display device supporting the same.

### Description of Related Art

Video signals are often obtained and reproduced on user display devices after undergoing various processes such as editing, encoding/decoding, transcoding, storage, and transmission on multiple systems. Each system that processes video signals performs necessary tasks according to predetermined standards and protocols. Therefore, due to various standards and protocols used in each process that the video signal goes through before reaching the user display device, the video signal delivered to the user display device may be distorted from the original signal.

Regarding video encoding technology, chroma subsampling technology is widely used. Chroma subsampling technology refers to a technique for encoding video signals by separating luminance (luma) signals and color (chroma) signals included in the video signals, and then decreasing the resolution of the color signals compared to the luminance signals. The human eye has about 90 million rod cells that detect luminance changes, while cone cells that recognize colors number about 6 million, and human vision is less sensitive to color changes compared to luminance changes. Due to these perceptual characteristics, reducing the resolution of color information compared to luminance information may not make a significant difference in human perception. Therefore, many video systems widely use chroma subsampling technology to reduce the data size required for information storage and/or transmission while minimizing loss of video information.

### SUMMARY

Embodiments of the disclosure provide a display device capable of reproducing enhanced quality video by correcting phase errors that color signals in video signals have with respect to luminance signals, and a video processing method in such a display device.

According to an example embodiment of the disclosure, an electronic device comprises: a communication interface comprising communication circuitry, a display configured to reproduce a video signal, memory storing at least one instruction, and at least one processor, comprising processing circuitry, electrically connected to the communication interface, the display, and the memory, wherein at least one processor, individually and/or collectively is configured to execute the at least one instruction and to cause the electronic device to: receive a video input through the communication interface, decode the video input, obtain, based on the video input, a set of luminance values and a set of color values corresponding to pixel positions of a series of pixels, determine, based on one set of the set of luminance values or the set of color values, a candidate set obtained by horizontally shifting positions of pixels corresponding to the one set by a specified value, determine a correlation between another set of the set of luminance values or the set of color values and the candidate set, and generate the video signal to be reproduced by the display based on the correlation.

According to an example embodiment of the disclosure, there is provided a video signal processing method comprising: obtaining a video input, decoding the video input, obtaining, based on the decoding, a luminance component value set and a color component value set corresponding to pixel positions of a series of pixels, obtaining, for one set of the luminance component value set and the color component value set, a first set of each change amount between each value corresponding to each pixel position and a value corresponding to a previous pixel position, obtaining, for another set of the luminance component value set and the color component value set, a second set of each change amount between each value corresponding to each pixel position and a value corresponding to a previous pixel position, determining, from one set selected out of the first set and the second set, a candidate set obtained by horizontally shifting positions of pixels corresponding to the one set by a specified value, determining a correlation between another set of the first set and the second set and the candidate set, and generating a video signal for reproduction based on the correlation.

According to various example embodiments of the disclosure, even when phase errors occur between color signals and luminance signals of a video signal processed by various standards and protocols, the display device may correct such phase errors in the video signal to reproduce video with clearer image quality.

Effects achievable by example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

In connection with the description of the drawings, the same or similar reference numerals may be used to denote the same or similar elements. Further, the above and other aspects, features and advantages of certain embodiments of the present disclosure will be more apparent from the following detailed description, taken in conjunction with the accompanying drawings, in which:

FIG. 1 is a diagram illustrating an example network environment in which a video signal may be transmitted to a display device according to various embodiments;

FIGS. 2A and 2B are diagrams illustrating various chroma subsampling schemes that may be applied when compressing video signals according to various embodiments;

FIGS. 3A, 3B, 3C and 3D are diagrams illustrating various sampling schemes that may be used when compressing video signals by applying chroma subsampling technology according to various embodiments;

FIG. 4 is a diagram illustrating an example video reproduced on a conventional display device, in which phase errors of color components with respect to luminance components occur;

FIGS. 5A and 5B are example graphs illustrating a luminance component value (Y) and a color component values (Cr) for each pixel positioned along line A-A′ of FIG. 4;

FIGS. 6A and 6B are graphs illustrating example change amounts of a luminance component value (Y) and a color component value (Cr) compared to a previous pixel for each pixel along line A-A′ of FIG. 4;

FIG. 7 is a block diagram illustrating an example configuration of a display device according to various embodiments;

FIG. 8 is a block diagram illustrating example functions of a video signal processing device according to various embodiments;

FIG. 9 is a flowchart illustrating example color signal phase error correction processing performed by a video processing device according to various embodiments;

FIG. 10 is a diagram illustrating an example processing procedure in which phase errors of color signals are corrected according to various embodiments;

FIGS. 11A and 11B are diagrams illustrating example video reproduced on a display device before and after correction of color signal phase errors according to various embodiments; and

FIG. 12 is a block diagram illustrating an example electronic device in a network environment according to various embodiments.

### DETAILED DESCRIPTION

Hereinafter, various example embodiments of the disclosure are described in greater detail with reference to the drawings. However, the disclosure may be implemented in other various forms and is not limited to the example embodiments set forth herein. The same or similar reference denotations may be used to refer to the same or similar elements throughout the disclosure and the drawings. Further, for clarity and brevity, no description may be made of well-known functions and configurations in the drawings and relevant descriptions.

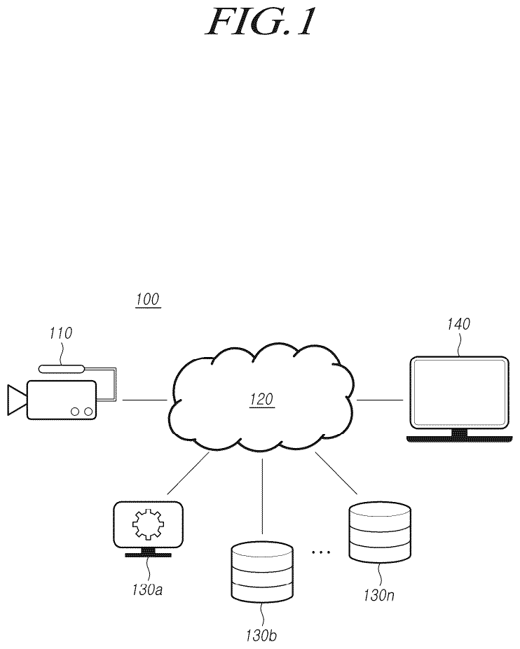

FIG. 1 is a diagram illustrating an example network environment in which a video signal may be transmitted to a display device according to various embodiments.

According to an embodiment, the network environment 100 may include a camera 110, a network 120, a plurality of video processing systems 130a-130n, and a display device 140. The camera 110, the plurality of video processing systems 130a-130n, and the display device 140 may transmit/receive information with each other through the network 120.

According to an embodiment, the camera 110 may capture a subject to generate captured video. The captured video may include moving pictures and still images. The camera 110 may include a lens and an image sensor. The lens may collect light from the subject to form an optical image in a shooting area. The lens may include a general-purpose lens, a wide-angle lens, and a zoom lens, but the disclosure is not limited thereto. The image sensor may generate a digital video signal from an optical signal. The image sensor may include a complementary metal oxide semiconductor (CMOS) and a charge coupled device (CCD), but the disclosure is not limited thereto.

The network 120 may support any communication protocol such as TCP/IP, UDP, HTTP, HTTPS, FTP, SFTP, or MQTT. According to an embodiment, the network 120 may support any wireless communication protocol such as GSM, CDMA, WCDMA, WiMAX, LTE, LTE-A, 5G, or 6G. The network 120 may include both wired and wireless communication networks. The wired communication network may include a cable network or a telephone network. The wireless communication network may include all networks that transmit and receive signals through radio waves. The wired communication network and the wireless communication network may be connected to each other. The network 120 may include a wide area network (WAN) such as the Internet, a local area network (LAN) formed around an access point (AP), and/or a short-range wireless network that does not pass through the AP. The short-range wireless network may include, but is not limited to, Bluetooth™ (IEEE 802.15.1), wireless LAN (WLAN), Zigbee (IEEE 802.15.4), Wi-Fi Direct, near field communication (NFC), and Z-wave.

According to an embodiment, the video signal obtained by the camera 110 may be edited, encoded/decoded, transcoded, stored, and/or transmitted in various ways by one or more video processing systems 130a-130n. The plurality of video processing systems 130a-130n may respectively process video signals as needed, and may encode/decode and/or transcode video signals according to predetermined standards and protocols. In an embodiment, each of the plurality of video processing systems 130a-130n may be of different or same types, and the disclosure is not limited to specific forms. In an embodiment, the video processing systems 130a-130n may include various content editing/providing servers such as broadcast servers, IPTV servers, OTT servers, video storage devices, and game servers, but the disclosure is not limited to specific forms.

The display device 140 may obtain a video signal from any one of the camera 110 and/or the plurality of video processing systems 130a-130n through the network 120. In an embodiment, the video signal obtained by the display device 140 may be a signal compression-encoded according to various schemes. In an embodiment, the video signal obtained by the display device 140 may include a luminance signal representing luminance for each pixel of the video and a color signal representing color for each pixel. According to an embodiment, the color signal may include a Cr signal and a Cb signal. In an embodiment, among the video signals obtained by the display device 140, the luminance signal and the color signal may be signals respectively compression-encoded at different resolutions. According to an embodiment, among the video signals obtained by the display device 140, the color signal may be a signal sampling-compressed at a lower resolution than the luminance signal according to a chroma subsampling scheme.

In an embodiment, the display device 140 may decode the compressed video signal. In an embodiment, the display device 140 may decode the compressed luminance signal to obtain a series of luminance component values. In an embodiment, the display device 140 may decode the compressed color signal to obtain a series of color component values.

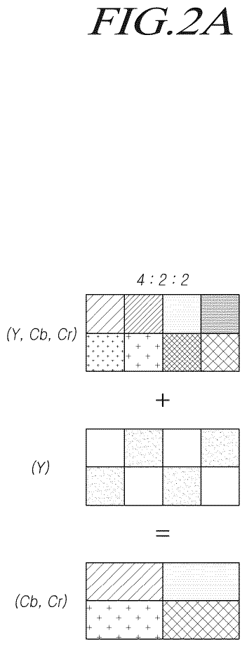

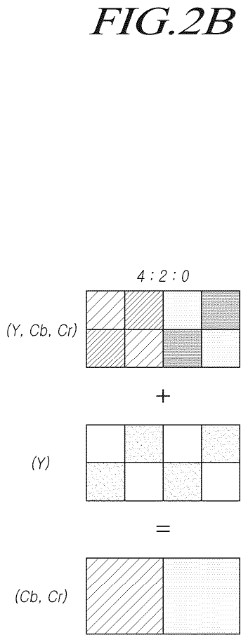

In an embodiment, the display device 140 may correct phase errors that the obtained color component values may have with respect to the luminance component values. As described above, among the video signals obtained by the display device 140, the color signal may be a signal that has been sampling-compressed according to chroma subsampling schemes at multiple stages before being obtained by the display device 140. Accordingly, phase errors of color component values for luminance component values obtained by the display device 140 may be present. According to an embodiment, the display device 140 may reproduce video of enhanced image quality by correcting such phase errors present in the color component values. Hereinafter, with reference to FIGS. 2 to 6, phase errors that color component values have with respect to luminance component values are described in greater detail.

FIGS. 2A and 2B are diagrams illustrating various example chroma subsampling schemes that may be applied when compressing video signals according to various embodiments.

Chroma subsampling schemes may be represented in the form of (a: b: c) according to the ratio of luminance component (Y) and color components (Cb, Cr). Here, “a” may represent a horizontal sampling reference unit. “b” represents the number of color component (Cb, Cr) samples among “a” samples in the first row, and “c” may represent the number of changed color component (Cb, Cr) samples, from the first row, among “a” samples in the second row.

FIG. 2A conceptually illustrates (4:2:2) sampling, which may be an example of chroma subsampling technology according to an embodiment of the disclosure. As illustrated, according to the (4:2:2) scheme, in a 4×2 pixel area, 4 luminance components and 2 color components may be sampled for the first row of 4 pixels, and 4 luminance components and 2 color components may be sampled for the second row of 4 pixels. According to the (4:2:2) method, the horizontal resolution of color components is decreased by ½, and the bandwidth for video signals may be decreased by ⅓ compared to when chroma subsampling technology is not used. Various video standards and formats adopt the (4:2:2) method. For example, the (4:2:2) sampling method is adopted in Digital Betacam, DVCPRO50, DVCPRO HD, Digital-S, etc.

FIG. 2B conceptually illustrates (4:2:0) sampling, which may be an example of chroma subsampling technology according to an embodiment of the disclosure. As illustrated, according to the (4:2:0) scheme, in a 4×2 pixel area, 4 luminance components and 2 color components may be sampled for the first row of 4 pixels, and 4 luminance components and 0 color components may be sampled for the second row of 4 pixels. According to the (4:2:0) method, the horizontal and vertical resolutions of color components are each decreased by ½, and the bandwidth for video signals may be decreased by ½ compared to when chroma subsampling technology is not used. Various video standards and formats adopt the (4:2:0) method. For example, the (4:2:0) sampling method is adopted in All ISO/IEC MPEG and ITU-T VCEG H.26x video coding standards, DVD-Video and Blu-ray Disc. [5][6], 576i “PAL” DV and DVCAM, HDV, AVCHD and AVC-Intra 50, Apple Intermediate Codec, JPEG/JFIF and MJPEG implementations, VC-1, WebP, etc.

These drawings and description are simply to aid in understanding of the disclosure and are not intended to limit the disclosure. According to various embodiments of the disclosure, various chroma subsampling methods other than the above-described (4:2:2) scheme or (4:2:0) scheme may be used, and the disclosure is not limited to specific examples.

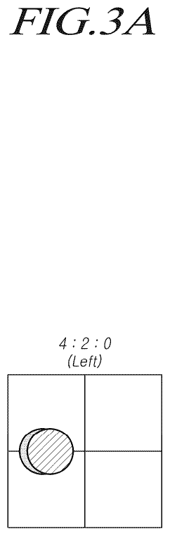

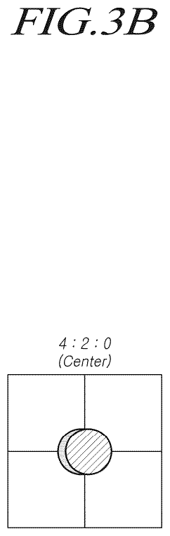

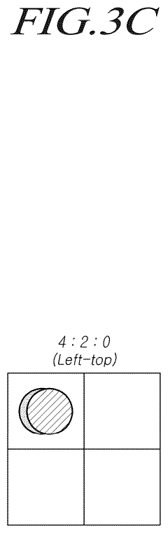

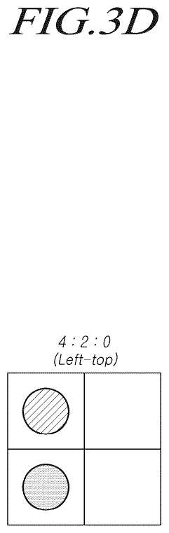

FIGS. 3A, 3B, 3C and 3D are diagrams illustrating various example sampling schemes that may be used when compressing video signals by applying chroma subsampling technology according to various embodiments.

Sampling schemes of chroma subsampling technology may be distinguished not only by the sampling ratio of color components as illustrated in relation to FIGS. 2A and 2B, but also by sampling positions of color components. FIGS. 3A, 3B, 3C and 3D illustrates various cases of varying positions where each color component is sampled when sampling one color component, specifically one Cr component and one Cb component, in a 2×2 pixel area (corresponding to 4 luminance components) according to, e.g., the (4:2:0) scheme. As an example, FIG. 3A illustrates a Left method in which both Cr component and Cb component are sampled at the vertical center of the left 2 pixels among the 2×2 4 pixels. As an example, FIG. 3B illustrates a Center method in which both Cr component and Cb component are sampled at the horizontal and vertical center of the 2×2 4 pixels. As an example, FIG. 3C illustrates a Left-top method in which both Cr component and Cb component are sampled at the top-left pixel among the 2×2 4 pixels. As an example, FIG. 3D illustrates another Left-top method in which the Cb component is sampled at the top-left pixel and the Cr component is sampled at the bottom-left pixel among the 2×2 4 pixels. As illustrated, in the case of color signals to which chroma subsampling is applied, color components at different positions may be sampled, and such differences in sampling positions may cause phase errors of color components with respect to luminance components in the decoding stage.

These drawings and description are simply to aid in understanding of the disclosure and are not intended to limit the disclosure. According to various embodiments of the disclosure, sampling positions of color signals may be determined in various ways other than those illustrated, and the disclosure is not limited to specific examples.

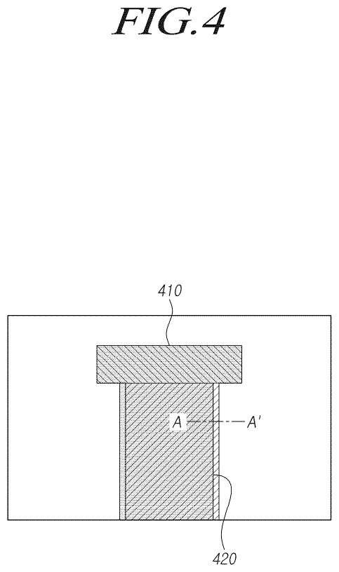

FIG. 4 is a diagram illustrating an example video reproduced on a conventional display device, in which phase errors of color components with respect to luminance components occur.

FIG. 4 illustrates an image 410 including a chimney-shaped object. Referring to FIG. 4, it may be identified that the color of the chimney-shaped object is slightly shifted from the boundary line of the object. In particular, looking at the right boundary line 420 of the chimney-shaped object, it may be observed that the reddish color of the object (the diagonally left hatched portion) protrudes slightly toward the right background.

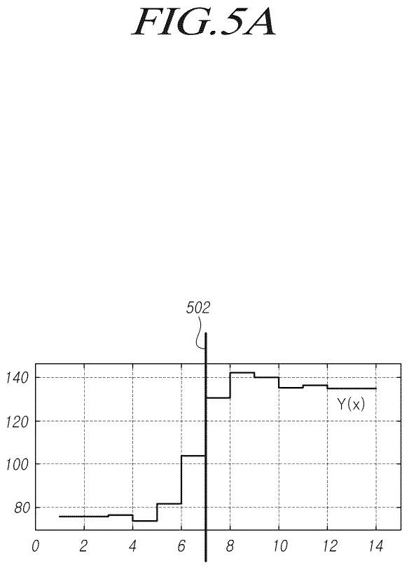

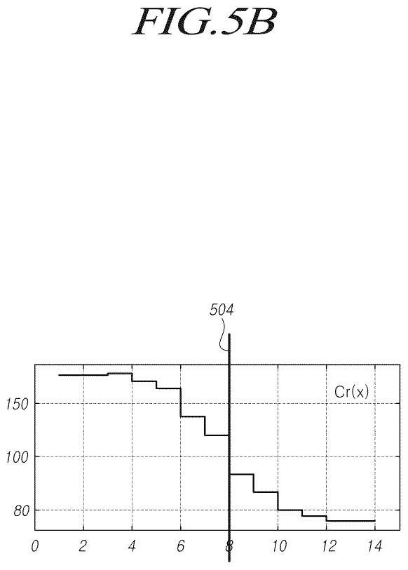

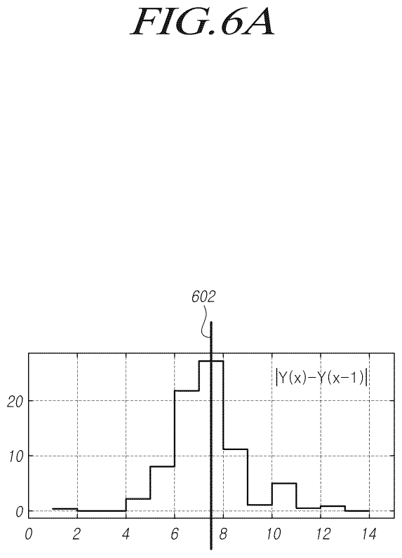

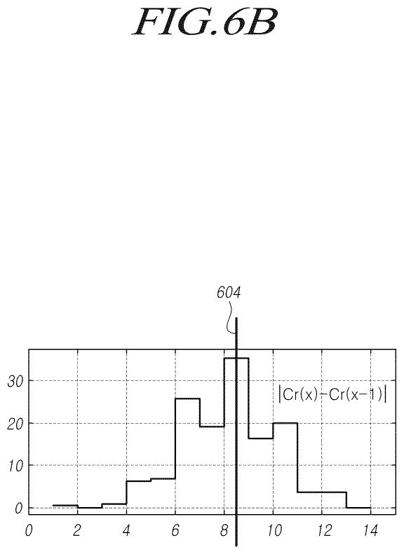

FIGS. 5A and 5B are graphs illustrating an example luminance component value (Y) and an example color component value (Cr) for each pixel positioned along line A-A′ of FIG. 4. FIGS. 6A and 6B are graphs illustrating example change amounts of a luminance component value (Y) and a color component value (Cr) compared to a previous pixel for each pixel along line A-A′ of FIG. 4.

In the graph illustrated in FIG. 5A, the X-axis represents each pixel position and the Y-axis represents each example luminance component value at each corresponding pixel. In the graph illustrated in FIG. 5B, the X-axis represents each pixel position and the Y-axis represents example color component value, particularly Cr component value, at each corresponding pixel. As illustrated, it may be identified that the position 502 where the change amount of the luminance component is greatest and the position 504 where the change amount of the Cr component is greatest do not coincide.

In the graph illustrated in FIG. 6A, the X-axis represents each pixel position and the Y-axis represents each change amount of luminance component value at each corresponding pixel from a previous pixel thereof. In the graph illustrated in FIG. 6B, the X-axis represents each pixel position and the Y-axis represents each change amount of color component value, particularly Cr component value, at each corresponding pixel from the previous pixel thereof. As illustrated, it may be identified that the position 604 where the change amount of Cr component value is greatest is shifted slightly to the right from the position 602 where the change amount of luminance component values is greatest. Such phase shift of color components may be identified from the video illustrated in FIG. 4.

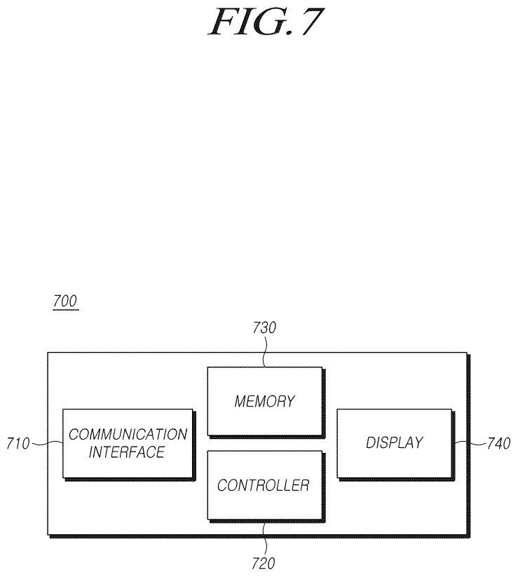

FIG. 7 is a block diagram illustrating an example configuration of a display device according to various embodiments. According to an embodiment, the display device 700 may be the display device 140 of FIG. 1.

According to an embodiment, the display device 700 may include a communication interface (e.g., including communication circuitry) 710, a controller (e.g., including circuitry) 720, memory 730, and a display 740. The display device 700 may include additional components in addition to the illustrated components, or may omit at least one of the illustrated components.

According to an embodiment, the communication interface 710 may include various communication circuitry and receive a video signal transmitted from the outside. The communication interface 710 may be implemented with at least one wired communication circuit or wireless communication circuit, and each communication circuit may support a predetermined bandwidth. It is understood by those skilled in the art that the communication interface 710 may transmit/receive data with the outside using various protocols.

According to an embodiment, the controller 720 may include various circuitry, e.g., processing circuitry, and perform overall control operations of the display device 700. The controller 720 may be implemented as a digital signal processor (DSP), a microprocessor, or a time controller (TCON) that processes digital signals. However, without limitations thereto, the controller 720 may include one or more of a central processing unit (CPU), a micro controller unit (MCU), a micro processing unit (MPU), a controller, an application processor (AP), a graphics processing unit (GPU), a communication processor (CP), or an ARM processor, or may be defined by corresponding terms. Further, the controller 720 may be implemented as a system on chip (SoC) with built-in processing algorithms, large scale integration (LSI), or may be implemented in the form of a field programmable gate array (FPGA). Further, the controller 720 may perform various functions by executing computer executable instructions stored in the memory 730. The controller 720 may be electrically connected to the memory 730, the communication interface 710, and the display 740. Thus, the controller 720 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the controller 720 may obtain a video signal received from the outside through the communication interface 710. According to an embodiment, the video signal received by the controller 720 may include a luminance signal and a color signal (e.g., Cr signal and Cb signal). The controller 720 may decode each of the received luminance signal and color signal, and correct phase errors of the color signal for the luminance signal as described below to generate a reproduction video signal. According to an embodiment, the controller 720 may cause the generated reproduction video signal to be stored in the memory 730 or reproduced through the display 740.

According to an embodiment, the memory 730 may be implemented as internal memory such as ROM (e.g., electrically erasable programmable read-only memory (EEPROM)) and RAM included in the controller 720, or may be implemented as a separate memory from the controller 720. In this case, the memory 730 may be implemented in the form of memory embedded in the display device 700 or in the form of memory detachable from the display device 700 according to data storage purposes. For example, data for driving the display device 700 may be stored in memory embedded in the display device 700, and data for an extension function of the display device 700 may be stored in memory detachable from the display device 700.

The memory embedded in the display device 700 may be implemented as at least one of, e.g., a volatile memory (e.g., a dynamic RAM (DRAM), a static RAM (SRAM), a synchronous dynamic RAM (SDRAM), etc.) or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD). The memory detachable from the display device 700 may be implemented as a memory card (e.g., compact flash (CF), secure digital (SD), micro secure digital (micro-SD), mini secure digital (mini-SD), extreme digital (xD), multi-media card (MMC), or the like), an external memory (e.g., USB memory) connectable to a USB port, or the like.

According to an embodiment, the display 740 may display video corresponding to the reproduction video signal generated by the controller 720. The display 740 may include various types of display panels such as a liquid crystal display (LCD) panel, a light emitting diode (LED) panel, an organic light emitting diode (OLED) panel, and a plasma display panel (PDP), and may include panel driving units for driving the display panel.

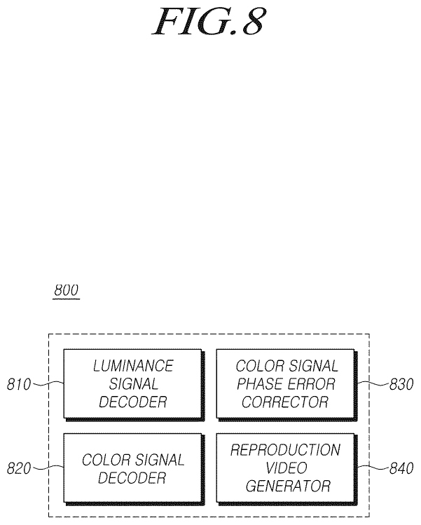

FIG. 8 is a block diagram illustrating various example functions of a video signal processing device according to various embodiments. According to an embodiment, the video processing device 800 may be implemented as at least a portion of the controller 720 of the display device 700 of FIG. 7.

According to an embodiment, the video processing device 800 may receive an encoded luminance signal and an encoded color signal. The received color signal may be a signal sampling-compressed according to a chroma subsampling scheme. According to an embodiment, the video processing device 800 may include a luminance signal decoder 810 and a color signal decoder 820, each of which may include various circuitry and/or executable program instructions. According to an embodiment, the luminance signal decoder 810 may receive the encoded luminance signal and decode the received luminance signal according to a predetermined algorithm to obtain a series of luminance component values. According to an embodiment, the color signal decoder 820 may receive the encoded color signal and decode the received color signal according to a predetermined algorithm to obtain a series of color component values. Although one color signal decoder 820 for the color signal is illustrated in this figure, the disclosure is not limited thereto. According to an embodiment of the disclosure, respective color signal decoders for each of the color signal Cr and the color signal Cb may be included in the video processing device 800.

According to an embodiment, the video processing device 800 may include a color signal phase error corrector 830, which may include various circuitry and/or executable program instructions. As described above, due to a series of processing procedures such as editing, storage, and transmission that the video signal undergoes after generation, phase errors of color component values compared to luminance component values obtained after decoding may be present. According to an embodiment, the color signal phase error corrector 830 may correct the phase errors, for luminance signals, present in color signals based on a relationship between changes in luminance components and changes in color signals.

According to an embodiment, the video processing device 800 may include a reproduction video generator 840 which may include various circuitry and/or executable program instructions. The reproduction video generator 840 may obtain decoded luminance component values from the luminance signal decoder 810. The reproduction video generator 840 may obtain phase error-corrected color component values from the color signal phase error corrector 830. The reproduction video generator 840 may generate a reproduction video signal to be displayed through the display using the luminance component values and the phase error-corrected color component values.

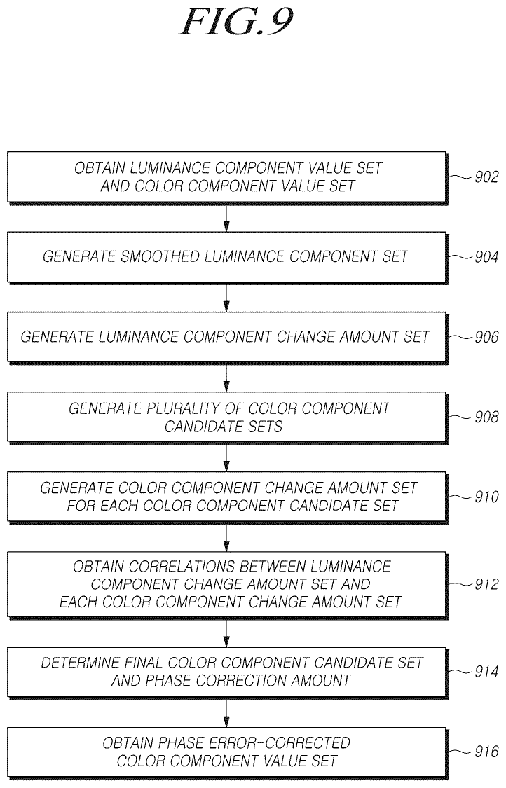

FIG. 9 is a flowchart illustrating example color signal phase error correction processing performed by a video processing device according to various embodiments. According to an embodiment, the color signal phase error correction processing illustrated in FIG. 9 may be implemented at least partially by the controller 720 of the display device 700 of FIG. 7 and/or the video processing device 800 of FIG. 8. The illustration in this figure is simply to aid in understanding, and the disclosure is not limited to specific examples.

According to an embodiment, in step 902, luminance component values and color component values for a series of pixels may be obtained. In an embodiment, the obtained luminance component values and color component values may be in a state of having the same resolution as each other after decoding processing has been performed in a previous step. In an embodiment, the series of pixels may respectively have position index x (0≤x<n, where x and n are natural numbers). In an embodiment, the luminance component values for the series of pixels obtained by decoding may be denoted as Yᵢₙ[x] and the color component values may be denoted as Cᵢₙ[x]. In an embodiment, the series of pixels may be pixels disposed in a horizontal direction. In an embodiment, the series of pixels may be pixels disposed in a vertical direction.

According to an embodiment, in step 904, the luminance component values Yᵢₙ[x] may be smoothed to generate a smoothed luminance component set Y[x]. The smoothing processing may be processing that removes high-frequency portions present in the luminance component values and reduces variability by applying a low-pass filter to the luminance component values Yᵢₙ[x]. In an embodiment, the smoothing processing for the luminance component values Yᵢₙ[x] may be performed according to Equation 1 below.

$$Y [ x ] = {\sum }_{t} f ( t ) {Y}_{in} ( x + t ) \qquad [ Equation 1 ]$$

Here, f(t) is a filter for smoothing processing, which may be, e.g., an average filter or a Gaussian filter, and the disclosure is not limited to specific cases. For example, when an average filter of size 5 is used for smoothing processing, f(t)=⅕ (−2≤t≤2). In this figure and related description, the case where the luminance component values Yᵢₙ[x] received in step 902 are smoothed in step 904 and Y[x] obtained therefrom is used for color signal phase error correction processing is mainly described, but the disclosure is not limited thereto. In an embodiment, the smoothing processing for the luminance component values Yᵢₙ[x] may be selectively performed for stable operation. In an embodiment, the smoothing processing of step 904 may be omitted, and the luminance component values Yᵢₙ[x] may be used for subsequent color signal phase error correction processing.

According to an embodiment, in step 906, a luminance component change amount set may be generated. According to an embodiment, from the smoothed luminance component set Y[x] generated in step 904, for each pixel position, an absolute value of change amount for a previous pixel position may be obtained, and a luminance component change amount set ΔY[x] may be generated therefrom. In an embodiment, the acquisition of the luminance component change amount set ΔY[x] may be represented by Equation 2 below.

$$Δ Y [ x ] = \vert Y [ x ] - Y ( x - 1 ) \vert \qquad [ Equation 2 ]$$

According to an embodiment, in step 908, a plurality of color component candidate sets may be generated. According to an embodiment, a plurality of phase correction amount candidate values P may be predetermined (e.g., specified). In an embodiment, the P value may represent a correction amount (e.g., number of pixels to be corrected) for phase error correction of color components, and may include a plurality of integers or real numbers. In an embodiment, the phase correction amount candidate value P may be, e.g., {−1, 0, +1}, and the disclosure is not limited thereto. In an example, P being −1 may refer, for example, to since the phase of the color signal for each pixel is shifted to the right by one pixel, it should be corrected to shift to the left by one pixel (e.g., shifting the corresponding pixel position of each color signal by −1). In an example, when a P value of −1 is determined as the final phase correction amount, the color component value at each pixel position may be corrected to the color component value at one right pixel. In an example, P being +1 may refer, for example, to since the phase of the color signal for each pixel is shifted to the left by one pixel, it should be corrected to shift to the right by one pixel (e.g., shifting the corresponding pixel position of each color signal by +1). In an example, when a P value of +1 is determined as the final phase correction amount, the color component value at each pixel position may be corrected to the color component value at one left pixel. According to an embodiment, in step 908, color component candidate sets Cₚ[x] for each of the plurality of predetermined phase correction amount candidate values P may be obtained. In an embodiment, the color component candidate set Cₚ[x] may be generated by Equation 3.

$${C}_{p} [ x ] = {C}_{in} [ x - p ] \qquad [ Equation 3 ]$$

In this example, the case where the phase correction amount candidate value P is three integer values has been mainly described, but the disclosure is not limited thereto. According to an embodiment, the phase correction amount candidate value P may be a larger or fewer number of integers or real numbers. According to an embodiment, when the phase correction amount candidate value P is a real number, the corresponding Cₚ[x] may be obtained through interpolation from color component values of pixels at integer positions adjacent to the P position.

According to an embodiment, in step 910, a color component change amount set may be generated for each of the color component candidate sets Cₚ[x]. According to an embodiment, from the color component candidate set Cₚ[x] generated in step 908, for each pixel position, an absolute value of change amount for previous pixel position may be obtained, and a color component change amount set ΔCₚ[x] may be generated therefrom. In an embodiment, the acquisition of the color component change amount set ΔCₚ[x] may be represented by Equation 4 below.

$$Δ {C}_{p} [ x ] = \vert {C}_{p} [ x ] - {C}_{p} [ x - 1 ] \vert \qquad [ Equation 4 ]$$

According to an embodiment, in step 912, the correlation between the luminance component change amount set ΔY[x] obtained in step 906 and the color component change amount set ΔCₚ[x] obtained in step 910 may be obtained. According to an embodiment, the correlation may be an index that measures the similar relationship between two signals. According to an embodiment, the correlation Cor[ΔY, ΔCₚ] between the luminance component change amount set ΔY[x] and the color component change amount set ΔCₚ[x] may be obtained by, e.g., Equation 5 below.

$$Cor [ Δ Y , Δ {C}_{p} ] = {\sum }_{x} \{ Δ Y [ x ] Δ {C}_{p} [ x ] \} \qquad [ Equation 5 ]$$

According to an embodiment, the correlation Cor[ΔY, ΔCₚ] between the luminance component change amount set ΔY[x] and the color component change amount set ΔCₚ[x] may indicate that the larger the value of the correlation is, the more it indicates that the directions of change of the luminance component signal and the color component signal are similar, e.g., the directions in which the luminance component signal and the color component signal increases or decreases together. According to an embodiment, in step 914, a final color component candidate set and a phase correction amount may be determined. In an embodiment, among the color component change amount sets ΔCₚ[x], a set having the largest value as the correlation Cor[ΔY, ΔCₚ] for the luminance component change amount set ΔY[x] may be determined as the final color component candidate set, and the corresponding P value may be determined as the final phase correction amount. In an embodiment, as described above, when Cor[ΔY, ΔCₚ] has the largest value, the corresponding color component change amount set ΔCₚ[x] may be determined to have the most similar change direction to the luminance component change amount set ΔY[x], and based on this point, the corresponding color component change amount set ΔCₚ[x] may be determined as the final color component candidate set. In this case, the given P value may become the final phase correction amount and may be determined by Equation 6 below.

$${P}_{opt} = arg {max}_{p} \{ Cor [ Δ Y , Δ {C}_{p} ] \} \qquad [ Equation 6 ]$$

According to an embodiment, in step 916, using the final color component candidate set and/or the final phase correction amount P obtained in step 914, a color component value set with phase error corrected may be obtained. In an embodiment, the color component value set with phase error corrected may be obtained by position-shifting each of the color component values before correction that were obtained by decoding by the final phase correction amount P. In an embodiment, the color component value set Cₒᵤₜ[x] with phase error corrected may be obtained by Equation 7.

$$Cout ( x ) = {C}_{in} [ x - {P}_{opt} ] \qquad [ Equation 7 ]$$

In FIG. 9 and related descriptions, it is described that with respect to change amounts of luminance component values for a series of pixels, each correlation of color component change amounts for each of a plurality of color component candidate sets obtained by shifting phases of color component values is used for color phase error correction, but the disclosure is not limited thereto. According to an embodiment, with respect to change amounts of color component values for a series of pixels, each correlation of luminance component change amounts for each of a plurality of luminance component candidate sets obtained by shifting phases of luminance component values may be used for color phase error correction.

In FIG. 9 and related descriptions, the case where the color signal phase error correction processing is performed according to a predetermined order is described, but the disclosure is not limited thereto. According to an embodiment, each step of the operational flow of FIG. 9 may be performed in a different order than illustrated. For example, as illustrated in FIG. 9, a plurality of color component candidate sets are first generated by shifting phases of color component values and then color component change amount sets for each color component candidate set are generated, but the disclosure is not limited thereto. In an embodiment, change amounts of color component values for a series of pixels may be first obtained, and then a plurality of color component candidate sets may be generated by shifting phases of the obtained change amounts of color component values. According to various embodiments of the disclosure, each step of the method for correcting color signal phase errors may be performed in various orders different from those illustrated in FIG. 9.

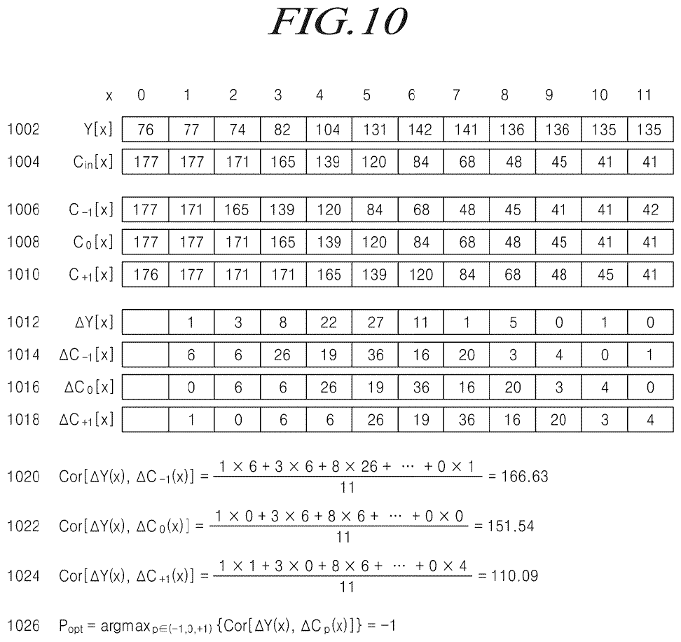

FIG. 10 is a diagram illustrating an example processing procedure in which phase errors of color signals are corrected according to various embodiments. According to an embodiment, the phase error correction of color signals illustrated in FIG. 10 may be implemented at least partially by the controller 720 of the display device 700 of FIG. 7 and/or the video processing device 800 of FIG. 8. The illustration in this figure is simply to aid in understanding, and the disclosure is not limited to specific examples.

According to an embodiment, a luminance component value set Y[x] 1002 and a color component value set Cᵢₙ[x] 1004 for 12 pixels having index x from 0 to 11 may be given. Although not specified in this figure, the given luminance component value set Y[x] 1002 may be a value after smoothing processing has been performed, but the disclosure is not limited thereto. According to an embodiment, the given color component value set Cᵢₙ[x] 1004 may be a set of Cr values obtained for each pixel. According to an embodiment, the given color component value set Cᵢₙ[x] 1004 may be a set of Cb values obtained for each pixel, but the disclosure is not limited to specific examples.

According to an embodiment, when the phase correction amount candidate value P is set to {−1, 0, +1}, color component candidate sets for each P value, e.g., C₋₁[x] 1006, C₀[x] 1008, and C₊₁ [x] 1010, may be obtained. In an embodiment, as described above, Cₚ[x]=Cᵢₙ[x-p] may be obtained.

According to an embodiment, a luminance component change amount set ΔY[x] 1012 may be generated. According to an embodiment, the luminance component change amount set ΔY[x] 1012 may be a set of values indicating how much the given luminance component value Y[x] of the pixel at position x has changed from the luminance component value Y[x−1] at the previous pixel position, e.g., x−1 pixel position.

According to an embodiment, a color component change amount set may be generated for each color component candidate set Cₚ[x] for each P. According to an embodiment, the color component change amount set ΔCₚ[x] may be a set of values indicating how much the given color component value Cₚ[x] of the pixel at position x has changed from the color component value Cₚ[x−1] at the previous pixel position, e.g., x−1 pixel position, in the given color component candidate set Cₚ[x]. As illustrated, according to an embodiment, a color component change amount set ΔC₋₁ [x] 1014 for the color component candidate set C₋₁ [x] when the phase correction amount candidate value P is −1 is illustrated. As illustrated, according to an embodiment, a color component change amount set ΔC₀[x] 1016 for the color component candidate set C₀[x] when the phase correction amount candidate value P is 0 is illustrated. As illustrated, according to an embodiment, a color component change amount set ΔC₊₁ [x] 1018 for the color component candidate set C₊₁[x] when the phase correction amount candidate value P is +1 is illustrated.

According to an embodiment, correlations between the luminance component change amount set ΔY[x] 1012 and the color component change amount sets for each color component candidate set Cₚ[x] for each P, e.g., ΔC₋₁ [x] 1014, ΔC₀[x] 1016, and ΔC₊₁[x] 1018, may be calculated. According to an embodiment, the correlation may be calculated according to, e.g., Cor[ΔY, ΔCₚ]=Σₓ {ΔY[x]ΔCₚ[x]}. In FIG. 10, at reference numeral 1020, the correlation for ΔC₋₁ [x] 1014 according to an embodiment, e.g., Cor[ΔY[x], ΔC₋₁ [x]], is shown as 166.63. In FIG. 10, at reference numeral 1022, the correlation for ΔC₀[x] 1016 according to an embodiment, e.g., Cor[ΔY[x], ΔC₀[x]], is shown as 151.54. In FIG. 10, at reference numeral 1024, the correlation for ΔC₊₁[x] 1018 according to an embodiment, e.g., Cor[ΔY[x], ΔC₊₁[x]], is shown as 110.09.

According to an embodiment, a final phase correction amount may be determined based on the generated correlations. According to an embodiment, the P value illustrating the largest correlation may be determined as the final phase correction amount. According to an embodiment, e.g., Pₒₚₜ=argmax_{p∈{-1,0,1}{Cor[ΔY, ΔC}ₚ]} may be determined as the final phase correction amount. In the illustrated example of this figure, −1 representing the largest correlation of 166.63 may be determined as the final phase correction amount, and the final phase correction amount thus determined is shown at reference numeral 1026.

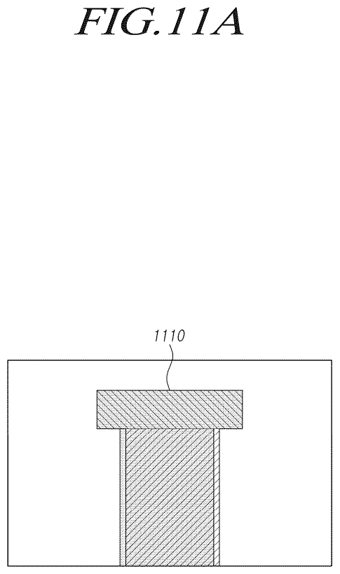

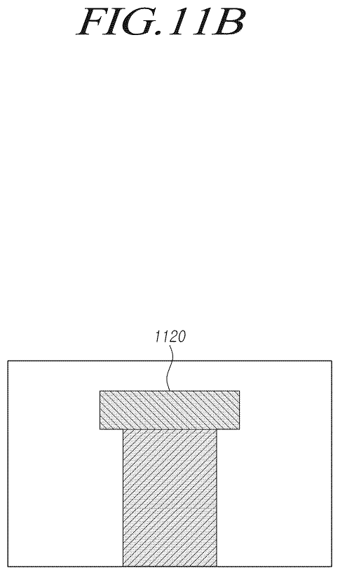

FIGS. 11A and 11B are diagrams illustrating example video reproduced on a display device before and after correction of color signal phase errors according to various embodiments.

FIG. 11A illustrates an image 1110 similar to that illustrated in FIG. 4. As illustrated, due to phase errors of color components with respect to luminance components, it may be observed that the color of the chimney-shaped object protrudes slightly from the boundary line of the object toward the right background.

FIG. 11B illustrates an image 1120 after correction of color signal phase errors according to an embodiment of the disclosure has been performed. In the case of this example, the phase error of the color component toward the right direction that was included in the image 1110 of FIG. 11A has been corrected to match the luminance component. In the case of the image 1120, it may be identified that the image quality deterioration that occurred in the image 1110 has been mitigated.

In various embodiments of the disclosure, what is referred to as color components may refer to each component signal included in color signals, e.g., each of Cr components or Cb components, or may refer to one signal in which they are combined. In the disclosure, the description has focused primarily on pixels disposed in a one-dimensional form in the horizontal direction, but the disclosure is not limited thereto. The various example embodiments of the disclosure may be applied to both horizontal and vertical directions to correct phase errors of color components with respect to luminance components that may occur in each direction.

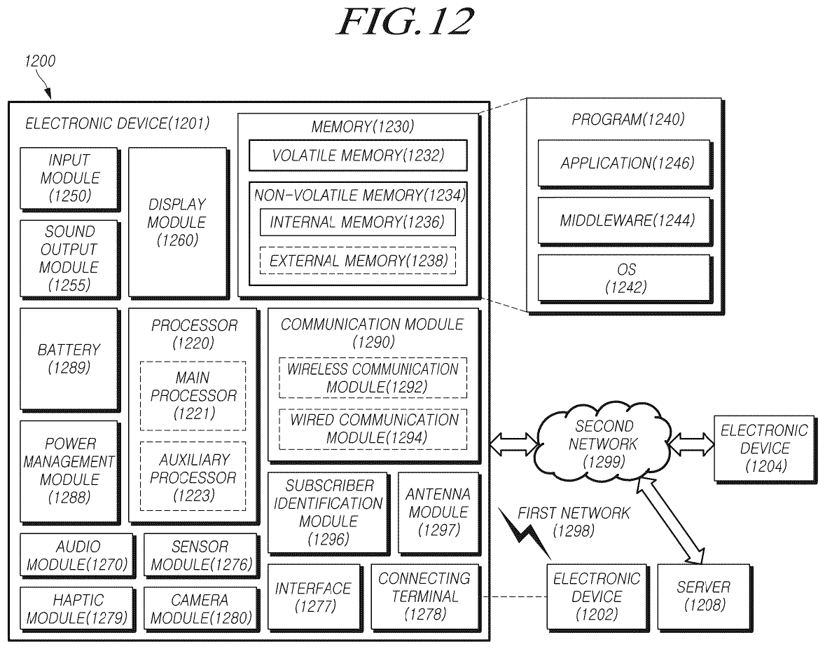

FIG. 12 is a block diagram illustrating an example electronic device 1201 in a network environment 1200 according to various embodiments. Referring to FIG. 12, the electronic device 1201 in the network environment 1200 may communicate with an electronic device 1202 via a first network 1298 (e.g., a short-range wireless communication network), or at least one of an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220, memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module (SIM) 1296, or an antenna module 1297. In various embodiments, at least one of the components (e.g., the connecting terminal 1278) may be omitted from the electronic device 1201, or one or more other components may be added in the electronic device 1201. In various embodiments, some of the components (e.g., the sensor module 1276, the camera module 1280, or the antenna module 1297) may be implemented as a single component (e.g., the display module 1260).

The processor 1220 may execute, for example, software (e.g., a program 1240) to control at least one other component (e.g., a hardware or software component) of the electronic device 1201 coupled with the processor 1220, and may perform various data processing or computation. According to an embodiment, as at least part of the data processing or computation, the processor 1220 may store a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), or an auxiliary processor 1223 (e.g., a graphics processing unit (GPU), a neural processing unit (NPU), an image signal processor (ISP), a sensor hub processor, or a communication processor (CP)) that is operable independently from, or in conjunction with, the main processor 1221. For example, when the electronic device 1201 includes the main processor 1221 and the auxiliary processor 1223, the auxiliary processor 1223 may be adapted to consume less power than the main processor 1221, or to be specific to a specified function. The auxiliary processor 1223 may be implemented as separate from, or as part of the main processor 1221. Thus, the processor 1220 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1223 may control at least some of functions or states related to at least one component (e.g., the display module 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223. According to an embodiment, the auxiliary processor 1223 (e.g., the neural processing unit) may include a hardware structure specified for artificial intelligence model processing. An artificial intelligence model may be generated by machine learning. Such learning may be performed, e.g., by the electronic device 1201 where the artificial intelligence is performed or via a separate server (e.g., the server 1208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input module 1250 may receive a command or data to be used by another component (e.g., the processor 1220) of the electronic device 1201, from the outside (e.g., a user) of the electronic device 1201. The input module 1250 may include, for example, a microphone, a mouse, a keyboard, a key (e.g., a button), or a digital pen (e.g., a stylus pen).

The sound output module 1255 may output sound signals to the outside of the electronic device 1201. The sound output module 1255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1260 may visually provide information to the outside (e.g., a user) of the electronic device 1201. The display module 1260 may include, for example, a display, a hologram device, or a projector and control circuitry to control a corresponding one of the display, hologram device, and projector. According to an embodiment, the display module 1260 may include a touch sensor adapted to detect a touch, or a pressure sensor adapted to measure the intensity of force incurred by the touch.

The audio module 1270 may convert a sound into an electrical signal and vice versa. According to an embodiment, the audio module 1270 may obtain the sound via the input module 1250, or output the sound via the sound output module 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, a HDMI connector, a USB connector, a SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to an embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The wireless communication module 1292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., the mmWave band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1297 may transmit or receive a signal or power to or from the outside (e.g., the external electronic device) of the electronic device 1201. According to an embodiment, the antenna module 1297 may include an antenna including a radiating element including a conductive material or a conductive pattern formed in or on a substrate (e.g., a printed circuit board (PCB)). According to an embodiment, the antenna module 1297 may include a plurality of antennas (e.g., array antennas). In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

According to various embodiments, the antenna module 1297 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 or 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, mobile edge computing (MEC), or client-server computing technology may be used, for example. The electronic device 1201 may provide ultra low-latency services using, e.g., distributed computing or mobile edge computing. In an embodiment, the external electronic device 1204 may include an internet-of-things (IOT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology.

According to an example, the electronic device may include a communication interface. The electronic device may include a display configured to reproduce a video signal. The electronic device may include memory storing at least one instruction. The electronic device may include at least one processor electrically connected to the communication interface, the display, and the memory, and configured to execute the at least one instruction. The at least one processor may be operated to receive a video input through the communication interface. The at least one processor may be operated to decode the video input. The at least one processor may be operated to obtain, based on the video input, a set of luminance values and a set of color values corresponding to pixel positions of a series of pixels. The at least one processor may be operated to, based on one set of the set of luminance values or the set of color values, determine a candidate set obtained by horizontally shifting positions of pixels corresponding to the one set by a predetermined value. The at least one processor may be operated to determine a correlation between another set of the set of luminance values or the set of color values and the candidate set. The at least one processor may be operated to generate the video signal to be reproduced by the display based on the correlation.

According to an example, the at least one processor may be operated to determine a plurality of the candidate sets each of which is obtained, for each of a plurality of predetermined P values, by horizontally shifting positions of pixels corresponding to the one set by the respective P value.

According to an example, the at least one processor may be operated to determine correlations between the another set and each of the candidate sets.

According to an example, the at least one processor may be operated to select one of the plurality of candidate sets based on the correlations.

According to an example, the at least one processor may be operated to generate the video signal to be reproduced by the display based on the selected candidate set.

According to an example, color component values corresponding to the pixel positions of the series of the pixels may be obtained according to the decoding.

According to an example, the set of color values may a set comprised of each absolute value of change amount between each color component value corresponding to each pixel position and a color component value corresponding to a previous pixel position.

According to an example, the candidate sets may be obtained from the set of color values.

According to an example, the set of color values may be a set of color component values obtained for the series of pixels according to the decoding.

According to an example, the candidate sets may be obtained from the set of color values.

According to an example, the determining of the correlation may include, for each of the candidate sets, obtaining a change amount set including each absolute value of change amount between a value in the candidate set corresponding to each pixel position and a value in the candidate set corresponding to a previous pixel position, and determining each correlation based on the set of luminance values and each of the change amount sets.

According to an example, the set of luminance values may be a set of luminance component values obtained for the series of pixels according to the decoding.

According to an example, the determining of the correlation may include comprises, obtaining a luminance value change amount set including each absolute value of change amount between a luminance component value in the set of luminance component values corresponding to each pixel position and a luminance component value in the set of luminance component values corresponding to a previous pixel position, and determining each correlation based on the luminance value change amount set and each of the change amount sets.

According to an example, the set of color values may be related to one of Cr values or Cb values obtained for the series of pixels.

According to an example, the luminance component values corresponding to the pixel position of the series of pixels may be obtained according to the decoding,

According to an example, the set of luminance values may be a set comprised of each absolute value of change amount between each luminance component value corresponding to a pixel position and a luminance component value corresponding to a previous pixel position.

According to an example, the candidate sets may be obtained from the set of luminance values.

According to an example, the set of luminance values may be a set of luminance component values obtained for the series of pixels according to the decoding.

According to an example, the candidate sets may be obtained from the set of luminance values.

According to an example, the determining of the correlation may include, for each of the candidate sets, obtaining a change amount set including each absolute value of change amount between a value in the candidate set corresponding to each pixel position and a value in the candidate set corresponding to a previous pixel position, and determining each correlation based on the set of color values and each of the change amount sets.

According to an example, the set of color values may be a set of color component values obtained for the series of pixels according to the decoding.

According to an example, the determining of the correlation may include obtaining a color value change amount set including each absolute value of change amount between a color component value in the set of color component values corresponding to each pixel position and a color component value in the set of color component values corresponding to a previous pixel position, and determining each correlation based on the color value change amount set and each of the change amount sets.

According to an example, the set of luminance values may be obtained by performing smoothing processing on luminance component values obtained for the series of pixels according to the decoding.

According to an example, the smoothing processing may be performed using an average filter or a Gaussian filter.

According to an example, each of the correlations between the another set and each of the candidate sets may be determined based on a total sum of products between a corresponding value in the candidate set and a corresponding value in the another set for each pixel position.

According to an example, each of the plurality of P values may be a predetermined integer or real number value, and when the P value is a real number, the candidate set for the P may be obtained by interpolation based on a set determined for an integer value P′ adjacent to the P.

According to an example, a video signal processing method of an electronic device may include obtaining a video input. The video signal processing method may include decoding the video input. The video signal processing method may include obtaining, based on the decoding, a luminance component value set and a color component value set corresponding to pixel positions of a series of pixels. The video signal processing method may include obtaining, for one set of the luminance component value set and the color component value set, a first set of each change amount between each value corresponding to each pixel position and a value corresponding to a previous pixel position. The video signal processing method may include obtaining, for another set of the luminance component value set and the color component value set, a second set of each change amount between each value corresponding to each pixel position and a value corresponding to a previous pixel position. The video signal processing method may include determining, from a selected one set of the first set and the second set, a candidate set obtained by horizontally shifting positions of pixels corresponding to the one set by a predetermined value. The video signal processing method may include determining a correlation between another set of the first set and the second set and the candidate set. The video signal processing method may include generating a video signal for reproduction based on the correlation.

According to an example, the determining of the candidate set may include determining a plurality of the candidate sets each of which is obtained, for each of a plurality of predetermined P values, by horizontally shifting positions of pixels corresponding to the one set by the respective P value.

According to an example, the determining of the correlation may include determining correlations between the another set and each of the candidate sets.

According to an example, the generating of the video signal for reproduction may select one of the plurality of candidate sets based on the correlations and generate the video signal for reproduction based on the selected candidate set.

According to an example, the luminance component value set may be obtained by performing smoothing processing on luminance component values obtained for the series of pixels according to the decoding.

According to an example, the smoothing processing may be performed using an average filter or a Gaussian filter.

According to an example, the determining of the correlations between the another set and each of the candidate sets may include determining each of the correlations based on a total sum of products between a corresponding value in the candidate set and a corresponding value in the another set for each pixel position.

According to an example, the color component value set may be related to one of Cr values or Cb values obtained for the series of pixels.

According to an example, each of the plurality of P values may be a predetermined integer or real number value, and when the P value is a real number, the candidate set for the P may be obtained by interpolation based on a set determined for an integer value P′ adjacent to the P.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, or any combination thereof, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the multi-display system 100 and the electronic device 110 described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
a communication interface comprising communication circuitry;
a display configured to reproduce a video signal;
memory storing at least one instruction; and
at least one processor, comprising processing circuitry, electrically connected to the communication interface, the display, and the memory, and individually and/or collectively configured to execute the at least one instruction,
wherein at least one processor, individually and/or collectively, is configured to cause the electronic device to:
receive a video input through the communication interface;
decode the video input;
obtain, based on the video input, a set of luminance values and a set of color values corresponding to pixel positions of a series of pixels;
determine, based on one set of the set of luminance values or the set of color values, a candidate set obtained by horizontally shifting positions of pixels corresponding to the one set by a specified value;
determine a correlation between another set of the set of luminance values or the set of color values and the candidate set; and
generate the video signal to be reproduced by the display based on the correlation.

2. The electronic device of claim 1, wherein at least one processor, individually and/or collectively, is configured to cause the electronic device to:
determine a plurality of the candidate sets each of which is obtained, for each of a plurality of specified P values, by horizontally shifting positions of pixels corresponding to the one set by the respective P value;
determine correlations between the another set and each of the candidate sets;
select one of the plurality of candidate sets based on the correlations; and
generate the video signal to be reproduced by the display based on the selected candidate set.

3. The electronic device of claim 2,
wherein color component values corresponding to the pixel positions of the series of the pixels are obtained according to the decoding,
wherein the set of color values includes a set comprised of each absolute value of change amount between each color component value corresponding to each pixel position and a color component value corresponding to a previous pixel position, and
wherein the candidate sets are obtained from the set of color values.

4. The electronic device of claim 2, wherein the set of color values includes a set of color component values obtained for the series of pixels according to the decoding,
wherein the candidate sets are obtained from the set of color values, and
wherein the determining of the correlation comprises, for each of the candidate sets, obtaining a change amount set including each absolute value of change amount between a value in the candidate set corresponding to each pixel position and a value in the candidate set corresponding to a previous pixel position, and determining each correlation based on the set of luminance values and each of the change amount sets.

5. The electronic device of claim 4, wherein the set of luminance values includes a set of luminance component values obtained for the series of pixels according to the decoding, and
wherein the determining of the correlation comprises, obtaining a luminance value change amount set including each absolute value of change amount between a luminance component value in the set of luminance component values corresponding to each pixel position and a luminance component value in the set of luminance component values corresponding to a previous pixel position, and determining each correlation based on the luminance value change amount set and each of the change amount sets.

6. The electronic device of claim 1, wherein the set of color values is related to one of Cr values or Cb values obtained for the series of pixels.

7. The electronic device of claim 2,
wherein the luminance component values corresponding to the pixel position of the series of pixels are obtained according to the decoding,
wherein the set of luminance values includes a set comprised of each absolute value of change amount between each luminance component value corresponding to a pixel position and a luminance component value corresponding to a previous pixel position, and
wherein the candidate sets are obtained from the set of luminance values.

8. The electronic device of claim 2, wherein the set of luminance values includes a set of luminance component values obtained for the series of pixels according to the decoding,
wherein the candidate sets are obtained from the set of luminance values, and
wherein the determining of the correlation comprises, for each of the candidate sets, obtaining a change amount set including each absolute value of change amount between a value in the candidate set corresponding to each pixel position and a value in the candidate set corresponding to a previous pixel position, and determining each correlation based on the set of color values and each of the change amount sets.

9. The electronic device of claim 8, wherein the set of color values includes a set of color component values obtained for the series of pixels according to the decoding, and
wherein the determining of the correlation comprises, obtaining a color value change amount set including each absolute value of change amount between a color component value in the set of color component values corresponding to each pixel position and a color component value in the set of color component values corresponding to a previous pixel position, and determining each correlation based on the color value change amount set and each of the change amount sets.

10. The electronic device of claim 2, wherein the set of luminance values is obtained by performing smoothing processing on luminance component values obtained for the series of pixels according to the decoding.

11. The electronic device of claim 10, wherein the smoothing processing is performed using an average filter or a Gaussian filter.

12. The electronic device of claim 2, wherein each of the correlations between the another set and each of the candidate sets is determined based on a total sum of products between a corresponding value in the candidate set and a corresponding value in the another set for each pixel position.

13. The electronic device of claim 2, wherein each of the plurality of P values is a specified integer or real number value, and
wherein based on the P value being a real number, the candidate set for the P is obtained by interpolation based on a set determined for an integer value P′ adjacent to the P.

14. A video signal processing method comprising:
obtaining a video input;
decoding the video input;
obtaining, based on the decoding, a luminance component value set and a color component value set corresponding to pixel positions of a series of pixels;
obtaining, for one set of the luminance component value set and the color component value set, a first set of each change amount between each value corresponding to each pixel position and a value corresponding to a previous pixel position;
obtaining, for another set of the luminance component value set and the color component value set, a second set of each change amount between each value corresponding to each pixel position and a value corresponding to a previous pixel position;
determining, from one set selected out of the first set and the second set, a candidate set obtained by horizontally shifting positions of pixels corresponding to the one set by a specified value;
determining a correlation between another set of the first set and the second set and the candidate set; and
generating a video signal for reproduction based on the correlation.

15. The video signal processing method of claim 14, wherein the determining of the candidate set comprises determining a plurality of the candidate sets each of which is obtained, for each of a plurality of predetermined P values, by horizontally shifting positions of pixels corresponding to the one set by the respective P value,
wherein the determining of the correlation comprises determining correlations between the another set and each of the candidate sets, and
wherein the generating of the video signal for reproduction comprises selecting one of the plurality of candidate sets based on the correlations and generating the video signal for reproduction based on the selected candidate set.

16. The video signal processing method of claim 14, wherein the luminance component value set is obtained by performing smoothing processing on luminance component values obtained for the series of pixels according to the decoding.

17. The video signal processing method of claim 16, wherein the smoothing processing is performed using an average filter or a Gaussian filter.

18. The video signal processing method of claim 15, wherein the determining of the correlations between the another set and each of the candidate sets comprises determining each of the correlations based on a total sum of products between a corresponding value in the candidate set and a corresponding value in the another set for each pixel position.

19. The video signal processing method of claim 14, wherein the color component value set is related to one of Cr values or Cb values obtained for the series of pixels.

20. The video signal processing method of claim 15, wherein each of the plurality of P values is a specified integer or real number value, and
wherein based on the P value being a real number, the candidate set for the P is obtained by interpolation based on a set determined for an integer value P′ adjacent to the P.
